(19) United States
(12) Patent Application Publication
(10) Pub. No.: US 2003/0087561 A1
(43) Pub. Date: May 8, 2003

(54) Electrical microconnector having an increased functional area for a locking mechanism

(76) Inventors: Achim Puettner, Hofen (DE); Uwe Steinhauser, Filderstadt (DE)

Correspondence Address: KENYON & KENYON, ONE BROADWAY, NEW YORK, NY, 10004, US

(21) Appl. No.: 10/278,236

(22) Filed: Oct. 23, 2002

(30) Foreign Application Priority Data
Oct. 23, 2001 (DE) 201 17 319.0

(51) Int. Cl. H01R 13/434

(52) U.S. Cl. 439/745

(57) ABSTRACT

As a rule, electrical microconnectors have a outer diameter of approximately 2 mm, the contact elements themselves having a dimension of approximately 0.63 mm. Described herein is a microconnector, which includes a housing and a plug connector situated in the housing. In addition, a primary and a secondary locking mechanism protect the microconnector against being unintentionally detached from a plug housing. The secondary locking mechanism acts on the end face of the microconnector facing in the direction opposite to the plugging direction. In order to now provide a greater contact area for the secondary locking mechanism, the end face is increased in size, in that the guide elements, which are necessary for inserting the microconnector in a directionally restricted manner and are provided on a side of the outer microconnector wall, extend to the end face of the microconnector, so that the end face of the guide elements and the end face of the microconnector form an enlarged surface.

### FIELD OF THE INVENTION

The present invention relates to a electrical microconnector made up of a housing, a plug connector situated in the housing, and a functional element for bringing about locking, the functional element having an end face, which faces in the direction opposite to the plugging direction and interacts with the locking mechanism.

### BACKGROUND INFORMATION

Microconnectors, which are used to produce an electrical plug connection and have a plug housing, have very small dimensions. As a rule, they have a maximum outer diameter of 2 mm, whereby electrical contact elements, which preferably have a dimension of 0.63 mm, are situated inside the connector. The plug itself has, as a rule, a circular cross-section, as well as guide elements that are used to couple the microconnector to a plug housing in a directionally and positionally correct manner.

Further exemplary embodiments of microconnectors are also designed to be able to fit into a plug housing while they are rotated 180° about their axis of rotation.

In some exemplary embodiments, the guide elements are made out of ridges, which are attached to the outer wall of the microconnector and may be inserted into corresponding grooves of a plug housing.

Alternatively, nubs may also be provided, which are attached to the outer wall of the microconnector and are guided into a groove of a plug housing during the plugging procedure.

In order to protect the plug connection between the microconnector and a plug housing produced in this manner, a so-called primary locking mechanism is provided on the outer wall of the microconnector. This primary locking mechanism locks into a plug housing as soon as an appropriate locking position is reached. Additionally provided is a so-called secondary locking mechanism, which is designed in such a manner, that a bolt or clip provided on the plug housing acts on the opposite microconnector endface (cable outlet) facing in the direction opposite to the plugging direction and holds this microconnector in its locked position. Thus, the bolt or the clip rests on the end face having a small area.

A fundamental disadvantage addressed by the present invention is that the contact surface of interaction of the bolt or clip provided for the secondary locking mechanism and the end face of the microconnector is very small. This limits the pulling-out forces that can act on the micro connector.

### SUMMARY OF THE INVENTION

An object of the present invention is to further develop the microconnector according to the related art, to the effect that the secondary locking mechanism is improved.

The object of the present invention is achieved by increasing the size of the microconnector end face, using a protuberance that is situated on a side of the outer wall.

An important advantage of the present invention is that the pulling-out forces that may act on a microconnector according to the related art may be compensated for by the secondary locking mechanism of the present invention, since the surface of action formed by a bolt or clip and the end face of the microconnector is considerably larger than that of the related art.

A further advantage of the present invention is that the outer dimensions of such a microconnector do not have to be changed, in order to attain an increased functional area for this secondary locking mechanism.

In addition, the secondary locking mechanism may be enlarged in a very simple manner, by either providing, in the region of the end face, an additional protuberance, which may be injection-molded onto, or formed in one piece with, the microconnector; or by bringing the guide elements, which are provided for directional insertion into a plug housing, up to the end face of the microconnector, so that the end face of the guide elements forms a plane with the end face of the rest of the microconnector, and thus increases the size of the end face accordingly.

The cross-section of the microconnector is preferably circular. Alternatively, the cross-section of the microconnector may be designed to be oval or rectangular or square, the protuberance itself either being provided on the entire circumference of the microconnector or, as an alternative, just in the regions that interact with a clip or bolt of the secondary locking mechanism. The cross-section of the latter is ear-like in its form.

### BRIEF DESCRIPTION OF THE DRAWINGS

FIG. 1 shows an enlarged side view of the microconnector according to the present invention, in a first contact position.

FIG. 2 shows a further, enlarged view of the microconnector according to the present invention, in another position.

FIG. 3 shows a top view of the microconnector according to FIGS. 1 and 2.

### DETAILED DESCRIPTION

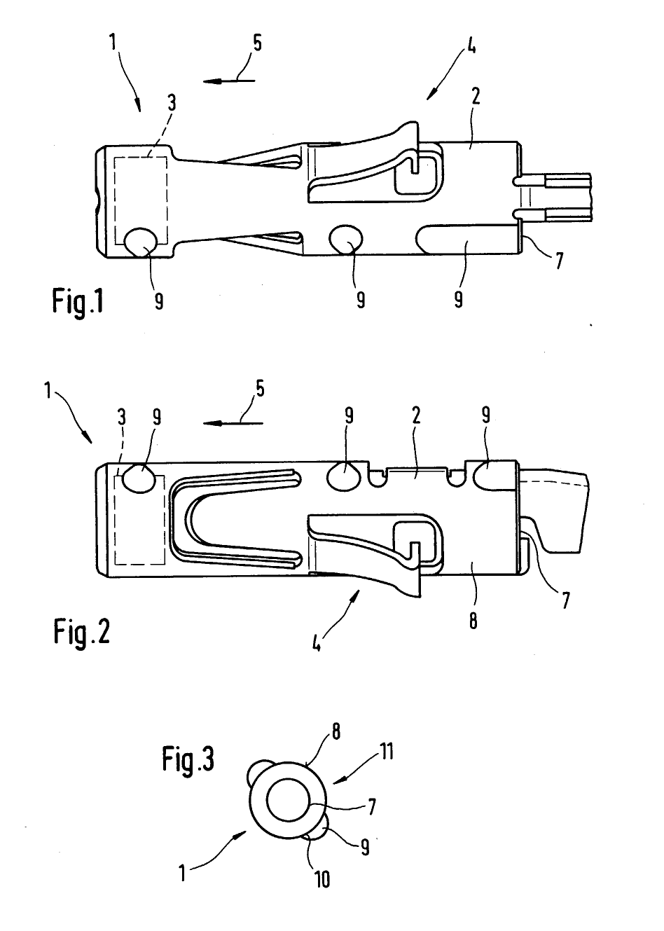

A microconnector I is represented in FIGS. 1 through 3. This microconnector 1 is made up of a housing 2 and a plug connector 3, which is situated in the housing and only sketched in the drawings.

Microconnector 1 also has a functional element 4, which takes the form of a primary locking mechanism in the exemplary embodiment represented in the drawing.

An additional functional element, which takes the form of a secondary locking mechanism, is schematically represented in FIG. 1 and FIG. 2, as well. This functional element takes the form of a bolt or clip and interacts with the end face 7 of microconnector 1 facing in the direction opposite to the plugging direction (arrow 5). In addition, guide elements 9 are provided on outer wall 8 of microconnector 1, the guide elements being provided for directionally restricted insertion of the microconnector into a plug housing not represented in the drawings. In the exemplary embodiments represented in FIGS. 1 through 3, these guide elements 9 are formed in the shape of nubs and protrude from the actual outer surface of outer wall 8 of microconnector 1.

The guide element 9 pointing towards end face 7 of microconnector 1 is formed in such a manner, that its end face 10 shown in the cross-sectional view of FIG. 3 terminates nearly flush with end face 7 of microconnector 1. Since end face 10 of guide element 9 and end face 7 of microconnector 1 terminate flush, the entire surface 11 formed by end face 10 of guide element 9 and end face 7 of microconnector 1 is increased in comparison with the designs known from the related art.

This allows the locking mechanisms not represented in the drawing, which are designed as part of the secondary locking mechanism, to have a larger contact surface, so that microconnector 1 is protected against greater pulling-out forces.

What is claimed is:

1. An electrical microconnector, comprising:
a housing;
a plug connector situated in the housing; and
a functional element for bringing about a locking, the functional element having an end face that faces in a direction opposite a plugging direction and interacts with a locking mechanism, wherein the end face is increased in size by a protuberance situated on a side of an outer wall of the microconnector.

2. The microconnector as recited in claim 1, wherein the protuberance includes a guide element for a directionally restricted insertion into a plug housing.

3. The microconnector as recited in claim 1, wherein a cross-section of the protuberance is ear-like.

4. The microconnector as recited in claim 1, wherein a cross-section of the microconnector is circular.

5. The microconnector as recited in claim 1, wherein a cross-section of the microconnector is oval.

6. The microconnector as recited in claim 1, wherein a cross-section of the microconnector is rectangular.

7. The microconnector as recited in claim 1, wherein the protuberance is injection-molded on.

8. The microconnector as recited in claim 1, wherein the protuberance is formed in one piece with the microconnector.
